(19) United States
(12) Patent Application Publication
(10) Pub. No.: US 2008/0248178 A1
(43) Pub. Date: Oct. 9, 2008

(54) Antistaling agent and methods

(76) Inventor: David A. Offord, Castro Valley, CA (US)

Correspondence Address: JACQUELINE S LARSON, 245 AVINGTON ROAD, ALAMEDA, CA, 94502, US

(21) Appl. No.: 12/080,136

(22) Filed: Mar. 31, 2008

Related U.S. Application Data
(60) Provisional application No. 60/921,809, filed on Apr. 4, 2007.

(51) Int. Cl. A21D 13/00

(52) U.S. Cl. 426/549

(57) ABSTRACT

The present invention relates to a process for regenerating stale bread and similar baked goods to extend its edible lifetime by incorporation of microencapsulated water into the baked goods, with the aim of extending the shelf life of the baked goods by releasing the water from the microcapsules when the goods begin to stale using microwaves from a typical home microwave oven.

This application claims the benefit of Provisional U.S. patent application Ser. No. 60/921,809, filed on Apr. 4, 2007.

### FIELD OF THE INVENTION

The present invention relates to a process for regenerating stale bread and similar baked goods from cereal products to extend its edible lifetime.

### BACKGROUND OF THE INVENTION

Bread, while consumed worldwide and considered an essential food item in most societies, is not a stable product. Thus, bread rapidly loses those desirable texture and flavor qualities associated with freshness (“staling”). Conventional lean breads, such as French or Italian loaves, stale significantly within twenty-four hours. Enriched breads, such as the familiar mass-produced, slice-wrapped white breads, have shelf lives of about five days. It has been estimated that international bread industry dollar losses due to staling are in the range of one billion dollars per year. Additionally, the short shelf life of commercial breads has resulted in the need for the baking industry to create and maintain production and distribution systems that operate within the limited window of saleability proscribed by the staling phenomena.

The experts unanimously believe that staling of baked articles is related to retrogradation of the starch and to the associated change in water-retention capacity. Starch is an essential constituent of baked articles, and is present in dough in the form of particles coated with protein. During the baking process the starch becomes gelatinized and absorbs copious water, while the protein coagulates. Immediately after baking, the starch begins to recrystallize (i.e., retrograde) and release water. The firmness of the crumb increases, although this is still regarded as an advantage in the first four hours. The sliceability and chewing characteristics improve at first. It is assumed that the unbranched starch fraction, or the amylose, crystallizes first, followed by the branched fraction of the starch, or the amylopectin, during further storage. In the meantime, the crumb becomes stiffer and in the course of time increasingly less elastic and eventually dry and hard: the bread has become stale.

Suppressing or circumventing this starch retrogradation phenomenon is the subject matter of numerous protective rights and publications.

In order to reduce the losses resulting from staling, cereal chemists have done considerable research pursuant to efforts to extend the shelf life of breads. This research is reported in numerous technical papers and includes use of preservatives, the reduction of package oxygen, the reduction of water activity and acidification. These previously proposed approaches to enhancement of bread shelf life have included such diverse techniques as controlled atmospheric packaging and the incorporation in the bread dough of additives which inhibit enzymatic and non-enzymatic browning. The previously reported techniques have exhibited only limited success.

One strategy for at least partly hindering the considerable firming of the crumb during storage has already been long known: the crumb is made in softer form from the beginning. The means of choice are emulsifiers such as lecithin, lysolethicin, diacetyltartaric acid esters or monoglyceride and diglyceride esters, which are added to the dough and produce crumb structure that is particularly soft from the beginning. It is also postulated that the monoglyceride and diglyceride esters on the one hand absorb the water released by recrystallization and on the other hand associate with the amylose, thus interfering with recrystallization thereof to the point that it can no longer proceed to completion. The use of alpha-amylase derived from fungi such as Aspergillus oryzae also has a similar effect. It acts upon damaged starch particles, thereby lowering the viscosity of the dough and producing fermentable sugar. As a consequence, the finished baked article has larger volume, which is consistent with softer crumb: the process of firming during aging is not as pronounced when the crumb is particularly soft. In addition to the fact that the fresh bread is too soft, the mold growth rate is increased due to the increased moisture.

A further strategy, specifically of preventing retrogradation by partial enzyme-mediated hydrolysis of the two starch fractions, is another method. It is assumed that the fragments produced by hydrolysis of the starch are too short to be able to recrystallize. The fragments associate with the remaining high molecular weight starch and largely prevent recrystallization thereof as well. In the experts' view, enzyme-mediated hydrolysis of the crumb should take place if possible at the gelatinization temperature, or in other words above about 70° C. These temperatures are reached and exceeded without difficulty in the baking process. The dilemma of enzyme treatment, however, is that only partial hydrolysis is permissible: not too little and not too much. If the degree of hydrolysis is too low, the freshness will not be retained. This is the case, for example, if starch-cleaving enzymes with too low thermal stability are used, such as the above-mentioned alpha-amylase derived from fungi. Such an enzyme has already lost its activity if gelatinization begins in the course of the thermal stress during the baking process, with the result that hydrolysis of the starch is too little.

Enzymatic retardation of staling by means of alpha-amylases has also been described, see for instance U.S. Pat. No. 2,615,810 and U.S. Pat. No. 3,026,205, as well as O. Silberstein, “Heat-Stable Bacterial Alpha-Amylase in Baking”, Baker's Digest 38(4), August 1964, pp. 66-70 and 72. The use of alpha-amylase for retarding the staling of bread has, however, not become widespread. The reason for this is assumed to be that the medium-molecular weight branched compounds, termed maltodextrins (with 20-100 glucose units in the molecule), generated through the hydrolytic action of alpha-amylases have a sticky consistency in themselves, resulting in the formation of a sticky or gummy crumb and consequently an unacceptable mouth-feel, of the baked product if the alpha-amylase is overdosed so that the maltodextrins are present in excessive quantities.

### SUMMARY OF THE INVENTION

The present invention overcomes the above-discussed and other deficiencies and disadvantages of processes for preventing the staling of baked goods. More particularly, the present invention is directed to the use of microencapsulated water, with the aim of extending the shelf life of the baked goods by releasing the water when the goods begin to stale using microwaves from a typical home microwave oven.

In one aspect, the present invention is directed to a baked article having improved antistaling properties, the baked article comprising microencapsulated water in an amount effective to regenerate the freshness of the baked article upon the rupture of the water-containing microcapsules.

In another aspect, the present invention is directed to a method for making baked articles, the method comprising incorporation of edible, microencapsulated water into the dough prior to baking; and baking the dough to obtain the baked good. The microencapsulated water may be incorporated into the dough by any appropriate means, such as for example, but not limited to: mixing the microencapsulated water with the flour prior to dough formation, mixing the microencapsulated water with one or more baking ingredients that are added to the flour or to the dough containing the flour, or adding the microencapsulated water directly to the dough. Alternatively, the water-containing microcapsules may be injected into the bread after it has been baked

The present invention is further directed to a method of preventing or reversing the staling of bread and other cereal-based baked goods, the method comprising incorporating edible, microencapsulated water into the dough prior to baking to give a baked product containing said microencapsulated water, and, when said baked product becomes stale, to expose said baked product to microwaves for a time sufficient to cause rupture of the water-containing microencapsules. Thus, once the bread becomes stale, the bread is rehydrated through microwave rupture of microcapsules containing water to release water into the bread.

By employing edible, food-grade microcapsules with non-porous shells capable of retaining water during the baking process, yet fragile enough to rupture upon microwave excitation of the encapsulated water, and employing these microcapsules in the proper amounts by weight of the water to the remaining constituents of a bread or other cereal-based dough, water may be reintroduced to stale bread at any time by placing the bread in a typical household microwave oven for a period of time sufficient to rupture the microcapsules, normally ten seconds or less at 1000 watts, for example.

While the discussion herein uses bread to exemplify the invention, the invention is not limited thereto but encompasses any product that is baked from a dough having a cereal base, such as but not limited to cookies, cakes, biscuits, muffins, and the like.

### DETAILED DESCRIPTION OF THE INVENTION

### Preparation of the Microencapsulated Water

There are many ways to microencapsulate water in the patent literature and many suitable microencapsulated water products available on the market. The water-containing microcapsules must be edible; that is, the microcapsule can be eaten by animals and, in particular, by humans. The microcapsule should be relatively stable; that is, it should be able to be transported and poured without immediate breakage and it should retain water during the baking process. At the same time, in a presently preferred embodiment, the microcapsule may be easily broken apart by appropriate means (by microwave excitation of the encapsulated water, for example) to release the entrapped water.

U.S. Pat. No. 6,413,548 entitled “Particulate Encapsulation of Liquid Beads” granted to Avika, Inc. (Woodbury Minn.) describes an example of the preparation of a suitable, commercially available water-containing microcapsule for use in the present invention. Example 4 of U.S. Pat. No. 6,413,548 will be used as the microencapsulated water product in the following Examples 2 and 3 herein, with the understanding that the present invention is not limited to these particular microcapsules. These microcapsules consist of a core of 90% by weight water and a shell composed of 3% TG-709 F Silica (unmilled) and 7% glycerin by weight.

### Application of the Microencapsulated Water

The water-containing microcapsules can be mixed in with the flour used for making the baked articles. They can also be contained in the baking ingredients that are added to the flour or dough. In many cases, however, they are mixed directly with the dough. They may also be injected into the bread after baking. The microencapsulated water according to the invention must be added in a quantity which is effective for the regeneration of stale bread. The quantity of microcapsules is usually defined in terms of water mass.

The analysis of water mass is performed as follows: Depending on type of flour and the intended baked article, generally from about 0.1 to about 20 g of water is used per 100 g of flour, preferably from about 1 to about 10 g of water and more preferably from about 3 to about 6 g per 100 g of flour. The exact quantity of water-containing microcapsules to be added will vary depending on factors such as the type of flour used, the type of baked product to be produced, the amount of water contained in the microcapsule itself, and the like, which quantity can be determined by one of ordinary skill in the art without undue experimentation.

There is also no need to do without the other usual additives in bread production. The microencapsulated water according to the invention can be advantageously combined with additives common to baking, such as enzymes and/or baking emulsifiers, water-soluble colloids, preservatives, and the like, without adverse effect.

### ADVANTAGEOUS EFFECTS

An advantageous freshness-regeneration effect is observed in the baked articles made by the process according to the invention. For example, white bread can be made fresh even after seven days of low humidity storage by irradiating the bread in a typical home microwave oven (e.g., 1000 watts) for only 10 sec on high power; the crumb becomes soft, and the crust is not leathery. High microencapsulated water dosages are not necessary to achieve the effect. Furthermore, the dosage tolerance is good: even with an overdose several times too large, the desired bread rehydration can be controlled by microwave power and/or time. The microencapsulated water according to the invention is completely edible. No change of flavor or texture of the bread is observed.

The softness of the crumb is regenerated by microwave irradiation of the water-containing microcapsules in the bread even after relatively long storage.

### EXAMPLES

### Performance of Baking Experiments

Baking procedure: In a spiral kneader (Kemper brand) a dough is prepared from 1500 g of flour, 870 mL of water, 45 g of yeast, 30 g of salt and 5 g of ascorbic acid. The dough is kneaded for two minutes at the lower stage 1 and for six minutes at the higher stage 2. Any microencapsulated water addition takes place in the aqueous phase at the beginning of the kneading process. The dough temperature is 26 to 27° C. After the dough has rested for 20 minutes, it is divided into four parts weighing 600 g each for making square-loaf white bread, placed in a baking pan, cooked for 75 minutes at 32° C. and 80% relative humidity, and then baked at 230° C. Using a compressimeter, the crumb firmness is determined on the freshly baked bread, and on the bread 24 hours and seven days after baking. Lower numbers correspond to softer crumb and thus to better freshness.

### Description of the Compressimeter Measurement

The compressimeter of the F. Watkins Corporation, West Caldwell, USA measures the compressibility of the crumb of the bread. It shows the force in scale divisions needed to indent the crumb to a given depth. A bread slice with 15 mm thickness is placed in the instrument and centered under the indenter. Scale D is set to zero with the right screw. A penetration depth of 3 mm is set for fresh bread and of 1.5 mm for old bread (storage time 1 to 7 days). For the measurement, the motor is turned on in order to push in the indenter by means of thread-operated tension. Once the desired penetration depth indicated on scale D has been reached, the motor is turned off and the applied force is read on scale J. The scale divisions correspond approximately to the weight in grams with which the indenter has indented the crumb. Low numbers correspond to soft crumb and thus also to better freshness.

### Examples 1 to 3

Baking cycles with the following microencapsulated water amounts were performed according to the above baking procedure:

Example 1: without microencapsulated water addition (comparison example)
Example 2: with 3 g of water-containing microcapsules per 100 g of flour.
Example 3: with 6 g of water-containing microcapsules per 100 g of flour.

After 1 or 7 days, the bread containing water microcapsules (from Examples 2 and 3) was irradiated in a 1000 watt microwave oven for 10 sec. The measurement of the freshness-retention effect was performed with the compressimeter in the manner described above.

TABLE 1
Compressimeter measurements

Compressimeter Measurement

| Example | Day 1 | Day 7 |
|---|---|---|
| 1 | 25 | 34 |
| 2 | 18 | 25 |
| 3 | 13 | 16 |

### Result

In the case of bread containing microencapsulated water, the better compressibility and thus the regeneration after microwaving of the softness of the crumb is evident even after seven days.

What is claimed is:

1. A baked article having improved antistaling properties, the baked article comprising flour and edible microencapsulated water in an amount effective to regenerate the freshness of the baked article upon the rupture of the microcapsules.

2. A baked article according to claim 1 wherein the microencapsulated water is present in an amount of from about 0.1 to about 20 g per 100 g of flour.

3. A mixture for making a baked article having improved antistaling properties, the mixture comprising flour and edible microencapsulated water in an amount effective to regenerate the freshness of the baked article upon the rupture of the microcapsules.

4. A mixture according to claim 3 wherein the microencapsulated water is present in an amount of from about 0.1 to about 20 g per 100 g of flour.

5. A method for making a baked article having improved antistaling properties, the method comprising:
incorporating edible microencapsulated water into the dough prior to baking, the water being in an amount effective to regenerate the freshness of the baked article upon the rupture of the microcapsules; and
baking the dough to obtain the baked article.

6. A method according to claim 5 wherein the microencapsulated water is present in an amount of from about 0.1 to about 20 g per 100 g of flour.
